(19) United States
(12) Patent Application Publication
(10) Pub. No.: US 2026/0186697 A1
(43) Pub. Date: Jul. 2, 2026

(54) TRAFFIC LOAD MANAGEMENT BETWEEN HIGH-BANDWIDTH MEMORY (HBM) AND NON-VOLATILE MEMORY (NVM) ON A SINGLE DIE

(71) Applicant: Micron Technology, Inc., Bosie, ID (US)

(72) Inventors: Xiangyu Tang, San Jose, CA (US); Jeffrey S. McNeil, Boise, ID (US); Eric N. Lee, San Jose, CA (US); Akira Goda, Tokyo (JP); Suresh Rajgopal, San Diego, CA (US); Sundararajan Sankaranarayanan, Fremont, CA (US)

(21) Appl. No.: 19/434,434

(22) Filed: Dec. 29, 2025

Related U.S. Application Data
(60) Provisional application No. 63/740,397, filed on Dec. 31, 2024.
(60) Provisional application No. 63/740,399, filed on Dec. 31, 2024.
(60) Provisional application No. 63/788,485, filed on Apr. 14, 2025.

(51) Int. Cl. G06F 3/06

(52) U.S. Cl. CPC G06F 3/0655; G06F 3/0604; G06F 3/0679

(57) ABSTRACT

A compute device includes a compute die disposed on a package substrate, and an on-chip cache disposed on the package substrate and coupled to the compute die. The on-chip cache includes volatile and non-volatile memory dies and a memory controller which is coupled between the compute die and the on-chip cache. The memory controller is configured to perform operations including receiving a request to write data to the on-chip cache, determining respective access bandwidths for the one or more volatile memory dies and the one or more non-volatile memory dies based on respective characteristics of the one or more volatile memory dies and the one or more non-volatile memory dies, and writing respective portions of the first data to the one or more volatile memory dies and the one or more non-volatile memory dies, wherein respective sizes of the respective portions are based on the respective access bandwidths.

### CLAIM OF PRIORITY

The present application claims the benefit under 35 U.S.C. § 119(e) of U.S. Provisional Ser. No. 63/788,485 filed Apr. 14, 2025, U.S. Provisional Ser. No. 63/740,397 , filed Dec. 31, 2024 and U.S. Provisional Ser. No. 63/740,399, filed Dec. 31, 2025, all of which are incorporated by reference herein.

### TECHNICAL FIELD

Implementations of the disclosure relate generally to compute devices, and more specifically, relate to traffic load management between high-bandwidth memory (HBM) and non-volatile memory (NVM) on a single die.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 is an example system employing a compute device having a hybrid on-chip cache (e.g., with combined volatile memory (VM) and NVM dies) on a processing die according to some embodiments.

FIG. 2 is an example system for traffic load management between high-bandwidth memory (HBM) and non-volatile memory (NVM) on a processing die, according to some aspects of the disclosure.

FIG. 3A is a flow chart of an example method for performing traffic load management between high-bandwidth memory (HBM) and non-volatile memory (NVM) on a processing die according to some aspects of the disclosure.

FIG. 3B is a flow chart of an example method for performing traffic load management between high-bandwidth memory (HBM) and non-volatile memory (NVM) on a processing die according to some aspects of the disclosure.

FIG. 4 is a flow chart of an example method 400 for performing traffic load management between high-bandwidth memory (HBM) and non-volatile memory (NVM) on a processing die according to some aspects of the disclosure.

FIGS. 5A-5B show example high-level component diagrams of hybrid NVM/HBM devices implemented in accordance with aspects of the present disclosure.

FIG. 6 schematically illustrates example logical and physical address spaces of the hybrid NVM/HBM devices implemented in accordance with aspects of the present disclosure.

FIG. 7 illustrates an example computing system that includes a memory sub-system implemented in accordance with some implementations of the present disclosure.

FIG. 8 is a block diagram illustrating a system for performing AI model inference operations using memory devices and/or host systems implemented in accordance with aspects of the present disclosure.

FIG. 9 is a block diagram of an example computer system in which implementations of the present disclosure may operate.

### DETAILED DESCRIPTION

Aspects of the present disclosure are directed to traffic load management between high-bandwidth memory (HBM) and non-volatile memory (NVM) on a processing die. A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, a host systems executing ML/AI frameworks can include multiple processing units or compute devices (e.g., graphics processing units (GPUs) and/or central processing units (CPU)) which can process multiple threads/streams in parallel. During the inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some implementations, the input data can be loaded from the memory sub-system to a local host memory co-located with the processing units executing the ML/AI framework. This host memory can be implemented using high-bandwidth memory (HBM) devices that offer extremely high (i.e., fast) performance, but have relatively low storage capacities.

In some implementations, multiple processing units or compute devices (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, the memory capacity is one of the biggest challenges faced by enterprise deployment of AI/ML models. Various solutions involve increasing the number of dies stacked in HBM packages accessible by a processing unit or compute device (e.g., a GPU) and implementing various non-uniform memory access (NUMA) schemes in which a processing unit, in addition to its local memory, may also access a local memory of another processing unit. However, these and other solutions fail to adequately satisfy the growing memory capacity requirements while delivering the requisite memory access bandwidth and latency, not to mention containing the costs.

Aspects of the present disclosure address the above and other deficiencies by integrating, within a single hybrid device, e.g., an integrated circuit (IC) on a common package substrate of a GPU and/or CPU, non-volatile memory (NVM) dies (e.g., NAND) with volatile memory (VM) dies (e.g., HBM dies) acting as an on-chip cache with respect to the NVM dies. Thus, in some embodiments, the hybrid compute device includes one or more processing units such as GPUs and/or CPUs, thus affording increased memory capacity on the same package as a compute die (e.g., in a memory cache used by the compute die for performing processing operations), reducing the need for off-package data movement operations between the memory dies because the VM/NVM dies are locally accessible by the compute die. Further, by storing the most-frequently accessed data in the VM or HBM dies, a higher number of hits at the faster memory can be realized due to more predictable, repetitive compute operations performed in AI/ML frameworks. In the case of a miss at the HBM dies, on-chip memory control can be configured to retrieve the data from the NVM dies and store the data in the HBM dies. In this way, the VM or HBM dies can operate as a type of first-level cache while the NVM dies can operate as a second-level cache, both on-die of the compute device and operating transparently to the compute die.

In illustrative embodiments, the hybrid compute device includes, in addition to the compute die, one or more one NVM dies, one or more HBM dies, and a logic die on which a local memory controller can reside. The local memory controller can perform the address translation and other local memory management tasks, which will be discussed in more detail. In some embodiments, the hybrid compute device includes one or more compute dies on which one or more processing units (GPUs and/or CPUs) reside.

The local memory controller can select respective access bandwidths for the NVM die(s) and the HBM die(s), referred to respectively as an “NVM bandwidth” and an “HBM bandwidth.” When the local memory controller receives an access request, the local memory controller can determine how to process the access request based on the NVM bandwidth and the HBM bandwidth. For example, when the local memory controller receives a write request to store data to the on-chip cache, the local memory controller can determine a first quantity of the write data to store at the NVM die(s) based on the NVM bandwidth and a second quantity of the write data to store at the HBM die(s) based on the HBM bandwidth.

In some embodiments, the local memory controller can use the quantity of data associated with the access request to further determine how to process the access request. For example, when the local memory controller receives a read request to read data from the on-chip cache, the local memory controller can determine a first quantity of the read data that will be read from the NVM die(s) and a second quantity of the read data that will be read from the HBM die(s). The local memory controller can then determine respective bandwidths for the NVM die(s) and the HMB module. That is, the local memory controller can determine the NVM bandwidth based on the first quantity of read data and the HBM bandwidth based on the second quantity of read data. In some embodiments, the local memory controller can use a type of data associated with one or more portions of the access request to further determine how to process the access request. For example, when the local memory controller receives a write request to write both short-term data and long-term data (as specified by the write request), the local memory controller can determine the NVM bandwidth based on the quantity of long-term data and the HBM bandwidth based on the quantity of short-term data.

The NVM bandwidth and the HBM bandwidth can change over time, based on characteristics of the NVM die(s) and the HBM die(s), respectively. Examples of characteristics that affect the module bandwidth include the logical capacity of the module, physical saturation of the module, temperature of the module, reliability of the module, or the like. The NVM die(s) and the HBM die(s) can have respective maximum bandwidths that are based on physical structures of each module and are thus predetermined during the manufacturing of the on-chip cache.

These and other advantages of the approaches described herein include the improved performance of memory devices and subsystems, which may be particularly beneficial when used in ML/AI frameworks, and will be described in more detail herein below. For example, AI/ML training and inference phases may be limited by the speed at which data is written to-or read from memory (e.g., the on-chip cache). Increasing the bandwidth at which data can be written to or read from the on-chip cache can improve training and inference phases of AI/ML models. Additionally, adjusting the bandwidth of each memory component of the on-chip cache can improve the overall utilization of the connection between the on-chip cache and compute device (e.g., optimize bandwidth utilization of the connection), leading to improved performance of the system.

A memory controller on a package substrate with an on-chip cache that includes volatile and non-volatile memory dies can receive a write command to write data to the on-chip cache. The memory controller can use characteristics of data in the write command, and/or characteristics of volatile and/or non-volatile memory dies of the on-chip cache to determine writing respective write bandwidths for the volatile and/or non-volatile memory dies.

In some implementations, one or more hybrid compute devices implemented in accordance with one or more aspects of the present disclosure may be packaged into a specified form factor, e.g., a form factor utilized by non-volatile memory devices, a form factor utilized by storage devices (such as solid state drives (SSDs)), or the like. Using a standard memory form factor would facilitate seamless integration of the device into various computing systems, such as, e.g., Internet-of-Things (IoT) devices, wearable or portable computing devices, automotive computing devices, enterprise compute systems, or enterprise storage systems, etc.

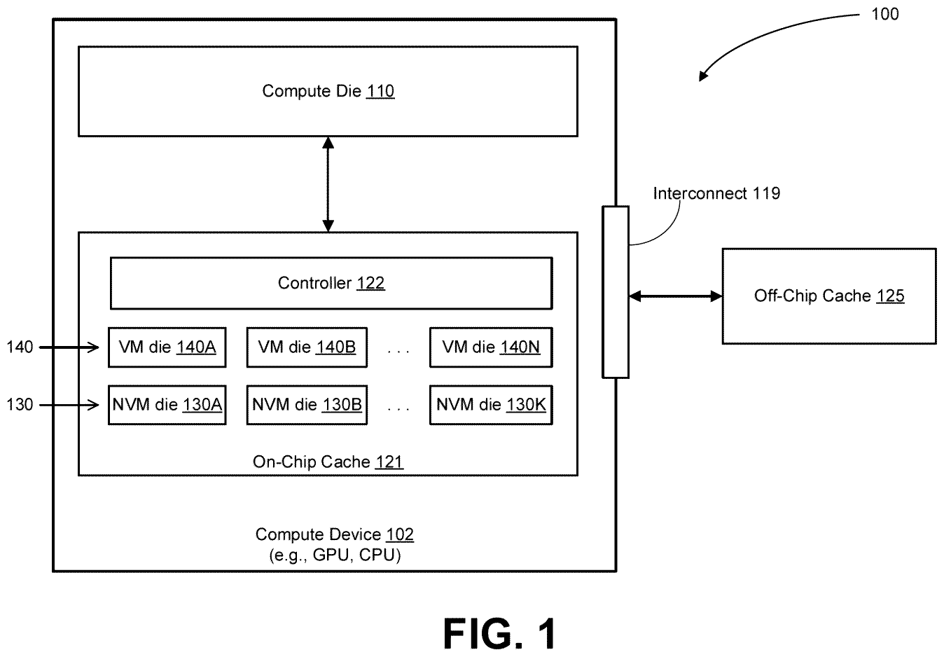

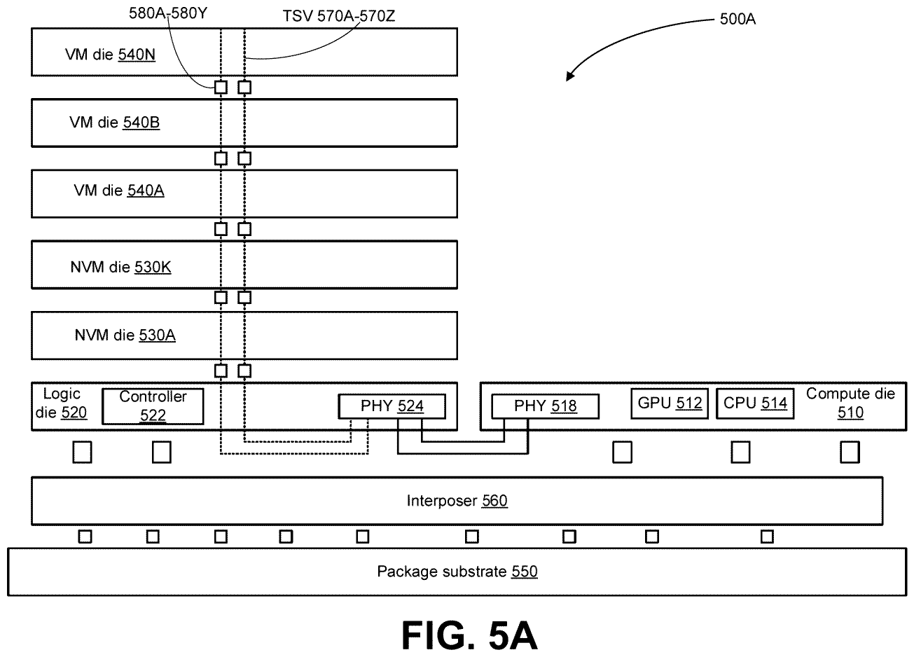

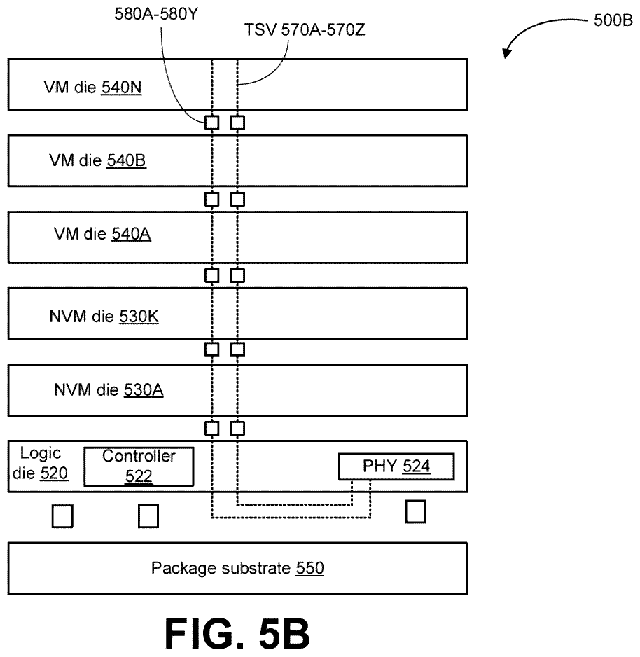

FIG. 1 is an example system 100 employing a compute device 102 having a hybrid on-chip cache 121 (e.g., combined VM and NVM dies) on a processing die according to some embodiments. The compute device 102 can include memory and compute components disposed on a common package substrate (see FIGS. 5A-5B). The system 100 can further include an interconnect 119 disposed on the package substrate and coupled to a off-chip cache 125 that is disposed off of the package substrate. In an embodiment, the interconnect 119 is a Peripheral Component Interconnect Express (PCIe) or other high-speed interface that connects components of a printed circuit board, e.g., like graphics cards, hard drives, and network adapters.

In some embodiments, the compute device 102 includes a compute die 110 disposed on the package substrate and the on-chip cache 121 disposed on the package substrate and coupled to the compute die 110. In embodiments, the on-chip cache 121 includes one or more volatile memory dies (e.g., VM dies 140, which can operate as a first-level cache) and one or more non-volatile memory dies (e.g., NVM dies 130, which can operate as a second-level cache). For example, the VM dies 140 can include a first VM die 140A, a second VM die 140B, through to an Nth VM die 140N, which can be DRAM, but for higher speed modern compute devices, may be HBM dies. Further, the NVM dies 130 can include a first NVM die 130A, a second NVM die 130B, through to a Kth NVM die 130K, which can be, for example, NAND dies or flash-based memory dies.

In some embodiments, the compute device 102 includes a memory controller 122, disposed on the package substrate, and coupled between the compute die 110 and the on-chip cache 121. Thus, the memory controller 122 can be located as part of the on-chip cache 121 or as stand-alone processing logic on a logic die (see FIGS. 5A-5B). In at least some embodiments, the memory controller 122 is configured to make management of the on-chip cache 121 transparent to the compute die 110.

For example, the memory controller 122 can make the combination of the VM dies 140 and the NVM dies 130 appear as uniform cache and manage address translations, compensation for delay between access speeds of VM dies compared to NVM dies, and other media management associated with the on-chip cache 121. The memory controller 122 can balance data-storing workloads across the VM dies 140 and the NVM dies 130, manage the NVM dies 130 for garbage collection and data integrity, and conduct caching and prefetching operations as between the VM dies 140 and the NVM dies 130, the latter of which will be described in more detail. In embodiments of balancing data storage, the data stored in the NVM dies 130 can be preemptively copied to the NVM dies 140 for faster access according a loading scheme and following various caching algorithms, which will be discussed.

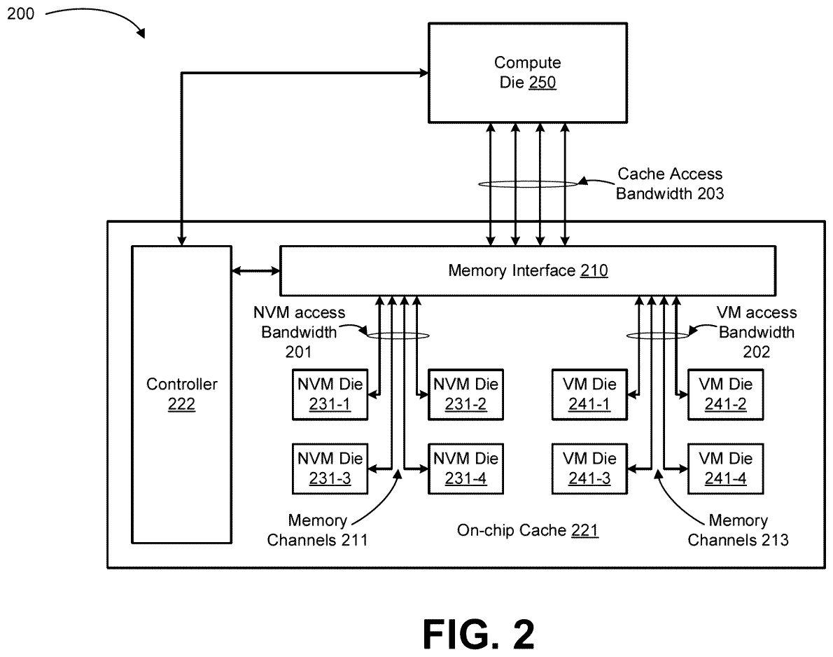

FIG. 2 is an example system 200 for traffic load management between high-bandwidth memory (HBM) and non-volatile memory (NVM) on a processing die, according to some aspects of the disclosure. In the example system 200, the on-chip cache 221 is connected to a compute die 250. The compute die 250 can be the same as or similar to the compute die 250 of FIG. 1

System 200 includes an on-chip cache 221, which can be the same as or similar to the on-chip cache 121 of FIG. 1. The on-chip cache 221 includes a controller 222, NVM die(s) 231-1, 231-2, 231-3, 231-4 VM die(s) 241-1, 241-2, 241-3, 241-4 connected to the compute die 250 by the memory interface 210. The controller 222 can be the same as or similar to the controller 122 of FIG. 1. The controller 222 can cause data to flow between the memory interface 210 and the coupled NVM die(s) 231-1, 231-2, 231-3, 231-4 at the NVM bandwidth 201. NVM die(s) 231-1, 231-2, 231-3, 231-4 can the same as or similar to NVM dies 130A-K of FIG. 1. The controller 222 can cause data to flow between the controller 222 and the coupled VM die(s) 241-1, 241-2, 241-3, 241-4 at the VM bandwidth 202. The VM die(s) 241-1, 241-2, 241-3, 241-4 can be the same as or similar to VM dies 140A-N of FIG. 1. The controller 222 can cause data to flow between the memory interface 210 and the coupled compute die 250 at one of (i) a sum of the NVM access bandwidth 201 and the VM access bandwidth 202, or (ii) the cache access bandwidth 203.

The controller 222 can receive a memory access request from a compute die 250. In some embodiments, the memory access request is a write request to write data to the on-chip cache 221. In some embodiments, the memory access request is a read request to read data from the on-chip cache 221. In some embodiments, the controller 222 can maintain a directory of data storage for the on-chip cache 221. That is, a directory of locations across the NVM dies 231 and/or VM dies 241 where data is stored. When the controller 222 receives the read or write request, the read or write request can include a reference to the directory maintained by the controller 222. Thus, to the external component that sends the read or write request via the memory interface 210, the “address” of the requested read or write data may be a location or address in a table of the directory maintained by the controller 222. In some embodiments, the controller 222 can transfer data between the one or more NVM dies 231 and/or the one or more VM dies 241. These data transfers can be recorded in the directory maintained by the controller 222.

The controller 222 can determine an access bandwidth of the NVM die(s) 231. That is, the controller 222 can determine the NVM access bandwidth 201 of the one or more NVM dies 231. The NVM access bandwidth can be based on one or more of a physical saturation of the NVM dies 231, a logical saturation of the NVM dies 231, a temperature of the NVM dies 231, a reliability of the NVM dies 231, a quantity of NVM dies 231, a number of memory channels 211 that access the NVM dies 231, a physical structure of memory cells of the NVM dies 231 (e.g., SLC/MLC/TLC/QLC) of the NVM dies 231, or the like.

The controller 222 can determine an access bandwidth of the VM die(s) 241-1, 241-2, 241-3, 241-4. That is, the controller 222 can determine the VM access bandwidth 202 of the one or more VM dies 241. The VM access bandwidth can be based on one or more of a physical saturation of the VM dies 241, a logical saturation of the VM dies 241, a number of memory channels 213 that access the VM dies 241, or the like.

As used herein, “physical saturation” can refer to one or more limitations of the memory die based on physical characteristics of the memory die. Examples of physical saturation include (i) physical bandwidth saturation of the memory interface 210, where the memory die reaches a threshold physical data transfer rate, (ii) physical storage saturation, where the memory die reaches a threshold quantity of physical memory cells that are storing data, or (iii) physical access saturation, where internal architecture of the memory die (e.g., controllers, caches, queues, etc.) are handing a threshold quantity of concurrent operations. In some embodiments, each of these thresholds can be represented as a respective percentage of a maximum value for the particular threshold. For example, the threshold data transfer rate can be a percentage (e.g., 90%) of a maximum data transfer rate (e.g., a predetermined maximum volatile bandwidth or a predetermined maximum non-volatile bandwidth). The percentage value can be determined based on the application of the system 200, and can span, for example, from approximately 80% to approximately 100%.

As used herein, “logical saturation” can refer to one or more limitations of the memory die based on logical characteristics of the memory die. Examples of logical saturation include (i) logical bandwidth saturation, where the memory die reaches a threshold logical data transfer rate (e.g., a maximum logical data transfer rate that is supported by external computing elements connected to the on-chip cache 221, such as the compute die 250), despite containing sufficient physical structures to sustain a physical data transfer rate (ii) logical storage saturation, where the memory die reaches a threshold quantity of logical storage locations that are storing data, despite containing sufficient physical storage locations, or (iii) logical access saturation, where the number of concurrent memory operations are limited by software, firmware, memory management limitations, or the like, despite containing physical resources to support a higher rate of concurrent access operations.

As used herein, “a reliability” of the NVM dies 231 can refer to a numerical representation of a predicted, calculated, or measured ability of the NVM dies 231 to retain data stored to the NVM dies 231. The numerical representation (e.g., a “reliability score”) can be based on one or more of a program/erase (P/E) count value, an error rate count, a data retention duration (e.g., a predicted, known, or actual data retention duration), or the like. The reliability score can be determined using the above example metrics, real-time wear-leveling data, error correction usage, and operating conditions (e.g., temperature, retention durations of currently stored data, etc.). In some embodiments, a higher reliability score can correspond to a more stable NVM die 231 (e.g., indicating that stored data is less likely to experience an error) while a lower reliability score can correspond to a less stable NVM die 231 (e.g., indicating that stored data is more likely to experience an error).

For a write request, the controller 222 can determine based on the determined respective access bandwidths (e.g., the NVM access bandwidth 201 and the VM access bandwidth 202) a quantity of data (e.g., a first quantity of data) to write to the NVM die(s) 230 (e.g., to the one or more NVM dies 231) and another quantity of data (e.g., a second quantity of data) to write the VM die(s) 241-1, 241-2, 241-3, 241-4 (e.g., to the one or more VM dies 241). The controller 222 can cause the write request to be performed by writing the first quantity of data to the NVM die(s) 230 and writing the second quantity of data to the VM die(s) 241-1, 241-2, 241-3, 241-4. That is, the controller 222 writes the first quantity of data to the NVM die(s) 230 at the NVM access bandwidth 201 and the second quantity of data to the VM module 202 at the VM access bandwidth 202. In some embodiments, the selected NVM access bandwidth 201 and the selected VM access bandwidth 202 can be selected to minimize a time to perform the write request.

For a read request, the controller 222 can use the locations of respective portions of the read data, sizes of the respective portions of the read data, or the like to determine the respective access bandwidths (e.g. the NVM access bandwidth 201 and the VM access bandwidth 202). That is, the selected access bandwidth for the NVM dies 231 can be larger if a larger amount of the requested data is stored on the NVM dies 231, and smaller if a smaller amount of the requested data is stored on the NVM dies 231. Similarly, the selected access bandwidth for the VM dies 241 can be larger if a larger amount of the requested data is stored on the VM dies 241, and smaller if a smaller amount of the requested data is stored on the VM dies 241. As further described herein, the determination of each access bandwidth can be made to minimize the length of performing a memory operation such as a write request. The controller 222 can read the portion of read data on the NVM die(s) 231 at the NVM access bandwidth 201, and the portion of read data on the VM die(s) 241 at the VM access bandwidth 202.

Each of the NVM die(s) 231 and the VM die(s) 241 can have a respective maximum access bandwidth, also referred to herein as the maximum non-volatile bandwidth and the maximum volatile bandwidth, respectively. The NVM access bandwidth 201 determined by the controller 222 will be less than or equal to the predetermined maximum non-volatile bandwidth and the VM access bandwidth 202 will be less than or equal to the predetermined maximum volatile bandwidth. The memory interface 210 between the controller 222 and a compute die such as compute die 110 of FIG. 1 can have a maximum on-chip cache bandwidth or cache access bandwidth 203. In some embodiments, the sum of the maximum volatile bandwidth and the maximum non-volatile bandwidth may be greater than the maximum on-chip cache bandwidth. That is, in some embodiments, concurrent access of the NVM die(s) 230 and the VM die(s) 241-1, 241-2, 241-3, 241-4 can be limited by the on-chip cache maximum bandwidth, and not by respective maximum bandwidths for either the NVM die(s) 231 or the VM die(s) 241. When the controller 222 determines the respective access bandwidths for the NVM dies 231 and the VM dies 241, the cache access bandwidth 203 can be a factor. In some embodiments, the controller 222 can determine the NVM access bandwidth 201 based on characteristics of the NVM die(s) 231 and/or characteristics of a portion of the access data and can determine the VM access bandwidth 202 as the difference between the cache access bandwidth 203 and the NVM access bandwidth 201. In alternative embodiments, the controller 222 can determine the VM access bandwidth 202 based on characteristics of the VM module 230 and/or characteristics of a portion of the access data and can determine the NVM access bandwidth 201 as the difference between the cache access bandwidth 203 and the VM access bandwidth 202.

In some embodiments, the controller 222 may determine respective access bandwidths for the NVM dies 231 and the VM dies 241 that do not fully utilize the cache access bandwidth 203. In some embodiments, a portion of the cache access bandwidth is used to perform a memory operation (e.g., a read operation or a write operation). That is, in some embodiments, the determined NVM access bandwidth 201 and the determined VM access bandwidth 202 may be selected such that a sum of the respective determined bandwidths is less than the cache access bandwidth 203. For example, the on-chip cache 221 may have an exemplary maximum bandwidth of 4 terabytes/second (Tb/s), the NVM die(s) 231 may have an exemplary maximum bandwidth of 2 Tb/s, and the VM die(s) 241 may have an exemplary maximum bandwidth of 3 Tb/s. The controller 222 may use one or more of (i) one or more characteristics of the NVM die(s) 231 and/or (ii) the access data to determine the NVM access bandwidth 201 (e.g., of 1 TB/s). The controller 222 may use one or more of (i) one or more characteristics of the VM die(s) 241 and/or (ii) the access data to determine the VM access bandwidth 202 (e.g., of 2 TB/s). Together, the NVM access bandwidth 201 and VM access bandwidth 202 represent a 3 Tb/s bandwidth, which is less than the exemplary maximum cache access bandwidth 203 (e.g., the exemplary 4 Tb/s).

In some embodiments, portions of one or more access requests (e.g., read requests and/or write requests) can be processed concurrently. For example, if a first read request is for read data that is entirely stored on the NVM die(s) 231, and a second read request is for read data that is entirely stored on the VM die(s) 241, the controller can determine the NVM access bandwidth 201 to read data from the NVM die(s) 231 for the first read request and the VM access bandwidth 202 to read data from the VM die(s) 241 for the second read request. Returning to the exemplary maximum bandwidth values above, the on-chip cache may have an exemplary maximum bandwidth of 4 terabytes/second (Tb/s), the NVM die(s) 231 may have an exemplary maximum bandwidth of 2 Tb/s, and the VM die(s) 241 may have an exemplary maximum bandwidth of 3 Tb/s. The controller 222 may select a NVM access bandwidth of 2 TB/s based on one or more of (i) one or more characteristics of the NVM die(s) 231 and/or (ii) the first read data, and a VM access bandwidth 202 of 2 Tb/s based on one or more of (i) one or more characteristics of the VM die(s) 241 and/or (ii) the second read data. Together, the NVM access bandwidth 201 and VM access bandwidth 202 represent a 4 Tb/s bandwidth, which is the same as the exemplary maximum bandwidth for the on-chip cache 221 (e.g., the exemplary 4 Tb/s). This allows the controller 222 to maximize the use of the on-chip access bandwidth, as if the controller 222 was limited to processing each read request sequentially, the on-chip access bandwidth would be underutilized at 2 Tb/s (e.g., 50% utilization) for the first read request and 3 Tb/s (e.g., 75% utilization) for the second read request. In some embodiments, the one or more access requests may be bundled together by a scheduler (not illustrated) for processing by the controller 222.

In some embodiments, the respective access bandwidths (e.g., the NVM access bandwidth 201 and the VM access bandwidth 202) can be determined based on an access threshold. The access threshold can be a minimum acceptable combined bandwidth of the NVM access bandwidth 201 and the VM access bandwidth 202. In some embodiments, the minimum acceptable combined bandwidth is limited by physical or logical constraints of the on-chip cache 221. For example, the memory interface 210 of the on-chip cache 221 may have a minimum data transfer rate that ensures that the on-chip cache 221 maintains a consistent connection with a compute die, such as the compute die 110 of FIG. 1. In some embodiments, the access request can be used to determine the minimum acceptable bandwidth. That is, the access request may have certain timing requirements that can only be satisfied if the combined bandwidth is above a minimum acceptable combined bandwidth.

In some embodiments, the respective bandwidths of the memory (e.g., the NVM access bandwidth 201 and the VM access bandwidth 202) and respective portions of the access data written to each memory die (e.g., the NVM dies 231 and the VM dies 241) can be determined such that the operations for each portion of the access data at each memory module complete at approximately the same time. That is, for write requests, after the controller 222 has determined the respective access bandwidths, the portions of the write data are selected such that writing the first portion of the write data to the NVM die(s) 231 at the NVM access bandwidth 201 will complete at approximately the same time that writing the second portion of the write data to the VM die(s) 241 at the VM access bandwidth 202. For example, if the NVM access bandwidth 201 is determined to be 1 Tb/s and the VM access bandwidth 202 is determined to be 2 Tb/s, for a combined on-chip cache bandwidth of 3 Tb/s, the controller 222 can determine to write ⅓ of the write data to the NVM die(s) 230 and ⅔ of the write data to the VM die(s) 241.

For read requests, after the controller 222 has determined a size of the portions of the read data that are stored on each of the memory modules, the respective bandwidths can be determined such that reading the first portion of the read data from the NVM die(s) 231 at the NVM access bandwidth 201 will complete at approximately the same time that reading the second portion of the read data from the VM die(s) 241 at the VM access bandwidth 202.

In some embodiments, the controller 222 can determine respective bandwidths for groups of access requests. For example, the controller 222 can change the NVM access bandwidth 201 and the VM access bandwidth 202 every certain number of access requests. Illustratively, the controller 222 can change the respective access bandwidths every fifth, tenth, etc. access request, as opposed to for each access request. In another example, the controller 222 can change the NVM access bandwidth 201 and the VM access bandwidth 202 based on the type of access request. Illustratively, the controller 222 can change the respective access bandwidths after a last read request of a group of read requests has been fulfilled before processing a first write request of a group of write requests. Illustratively, the controller can change the respective access bandwidths after a last write request of a group of write requests has been fulfilled before processing a first read request of a group of read requests. In another example, sets of access requests may be bundled together based on a common workload, requesting device, destination, or the like, and the controller can similarly determine new respective access bandwidths after each bundled group of access requests have been performed before processing a new bundled group of access requests. In some embodiments, the controller 222 can refrain from determining new respective access bandwidths for a particular access request. For example, if the controller 222 is processing multiple similar write requests that have the same or similar bandwidth requirements, but a read request is included in the middle of the similar write requests (e.g., as a priority access request, as a part of processing the multiple write request, etc.), the controller 222 can fulfill the read request using the same determined respective access bandwidths, without determining new access bandwidths for the read request and then re-determining new access bandwidths for the subsequent write requests that are similar to the previously performed write requests.

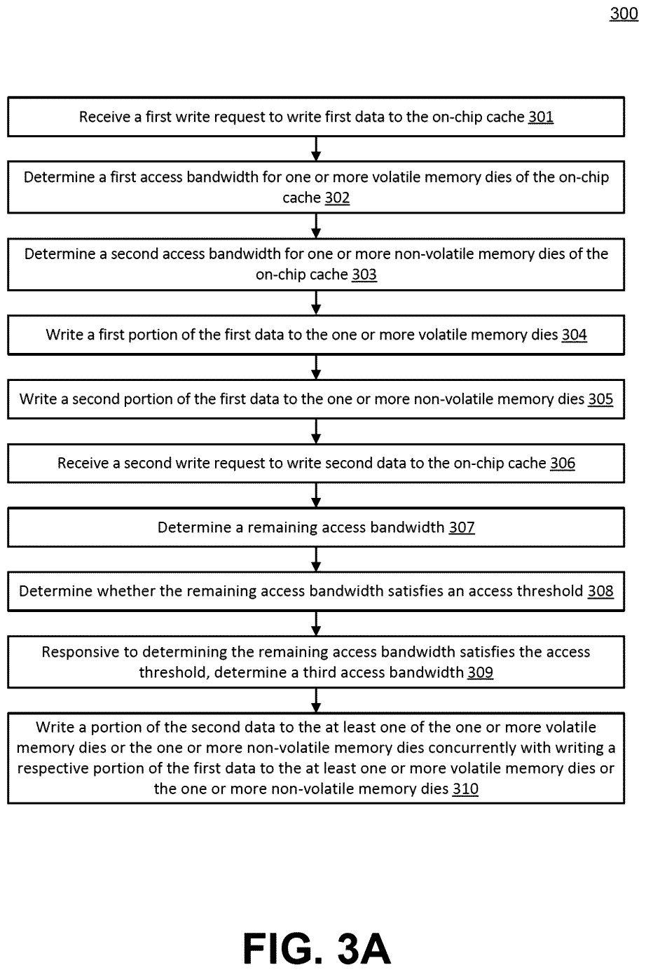

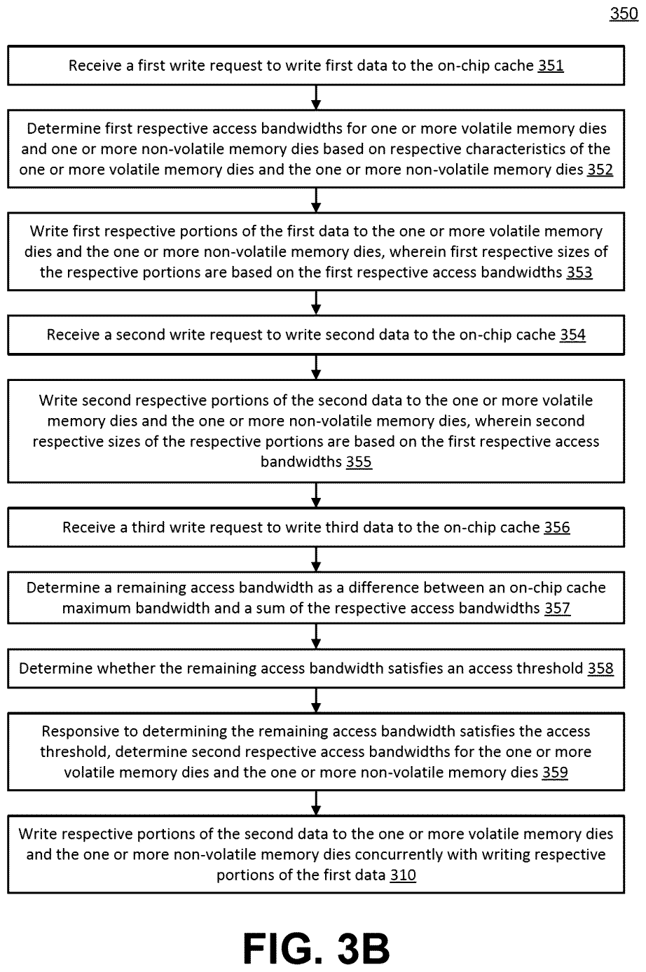

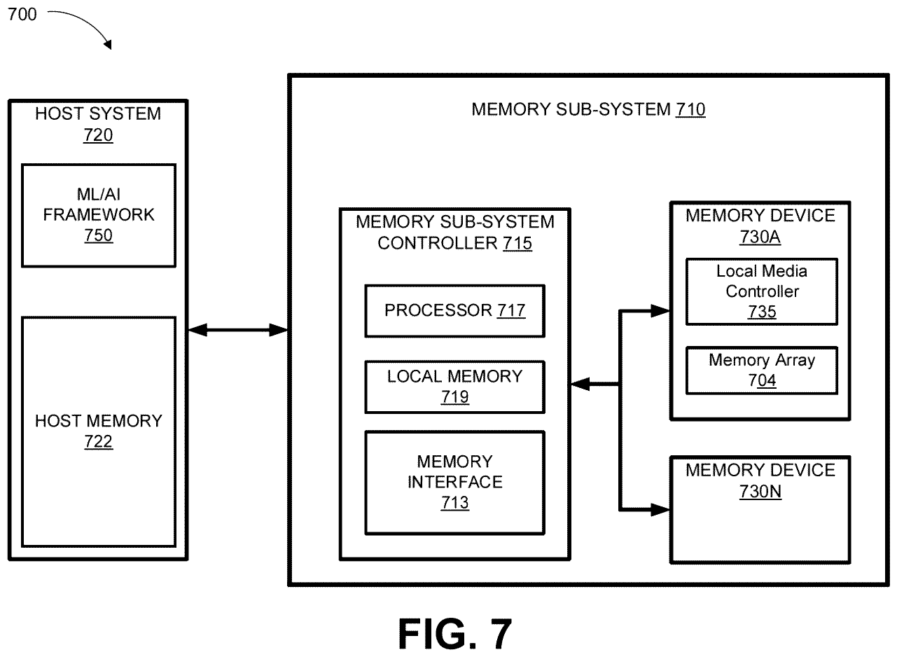

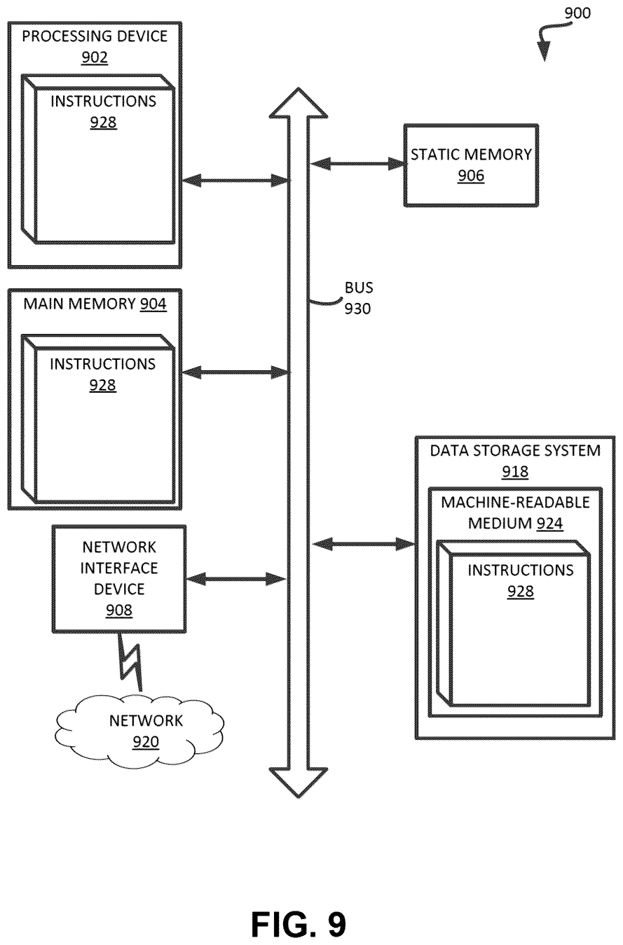

FIG. 3A is a flow chart of an example method 300 for performing traffic load management between high-bandwidth memory (HBM) and non-volatile memory (NVM) on a processing die according to some aspects of the disclosure. The method 300 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 300 is performed by the controller 122 of FIG. 1 and/or the controller 222 of FIG. 2. In another illustrative example, the method 300 is performed by the memory sub-system controller 715 of FIG. 7. In another illustrative example, the method 300 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 301, the controller performing the method 300 receives a first write request to write first data to the on-chip cache.

At operation 302, the controller determines a first access bandwidth for one or more volatile memory dies of the on-chip cache. In some embodiments, one or more characteristics of the one or more volatile memory dies are used to determine the first access bandwidth.

At operation 303, the controller determines a second access bandwidth for one or more non-volatile memory dies of the on-chip cache. In some embodiments, one or more characteristics of the one or more non-volatile memory dies are used to determine the second access bandwidth.

At operation 304, the controller writes a first portion of the first data to the one or more volatile memory dies. In some embodiments, the first access bandwidth is used to determine a first size of the first portion of the first data written to the one or more volatile memory dies.

At operation 305, the controller writes a second portion of the first data to the one or more non-volatile memory dies. In some embodiments, the second access bandwidth is used to determine a second size of the first portion of the first data written to the one or more non-volatile memory dies.

At operation 306, the controller receives a second write request to write second data to the on-chip cache. In some embodiments, the second write request is received prior to a completion of the first write request.

At operation 307, the controller determines a remaining access bandwidth. In some embodiments, the remaining access bandwidth can be determined as a difference between an on-chip cache maximum bandwidth and a sum of the first access bandwidth and the second access bandwidth.

At operation 308, the controller determines whether the remaining access bandwidth satisfies an access threshold. In some embodiments, one or more characteristics of data to be written, one or more characteristics of the on-chip cache, or of the volatile or non-volatile memory dies, including timing characteristics are used to determine the access threshold. For example, the access threshold can be a minimum data transfer rate for performing a particular memory access operation. In another example, the access threshold can be a minimum data quantity transfer size (e.g., the second data or first or second portion of the second data is larger than a minimum data transfer size for writing the second data size).

At operation 309, responsive to determining the remaining access bandwidth satisfies the access threshold, the controller determines a third access bandwidth. In some embodiments, the third access bandwidth is determined for at least one of the one or more volatile memory dies or the one or more non-volatile memory dies.

At operation 310, the controller writes a portion of the second data to at least one of the one or more volatile memory dies or the one or more non-volatile memory dies concurrently with writing a respective portion of the first data to the at least one or more volatile memory dies or the one or more non-volatile memory dies.

FIG. 3B is a flow chart of an example method 350 for performing traffic load management between high-bandwidth memory (HBM) and non-volatile memory (NVM) on a processing die according to some aspects of the disclosure. The method 350 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 350 is performed by the controller 122 of FIG. 1 and/or the controller 222 of FIG. 2. In another illustrative example, the method 350 is performed by the memory sub-system controller 715 of FIG. 7. In another illustrative example, the method 350 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 351, the controller performing the method 350 receives a first write request to write first data to the on-chip cache. In some embodiments, the first write request is received from one or more processing devices of a graphics processing unit (GPU). In some embodiments, the on-chip cache can be one component in a GPU system.

At operation 352, the controller determines first respective access bandwidths for one or more volatile memory dies and one or more non-volatile memory dies based on respective characteristics of the one or more volatile memory dies and the one or more non-volatile memory dies. In some embodiment, a sum of the respective bandwidths satisfies a predetermined access threshold. In some embodiments, the predetermined access threshold is based on an on-chip cache access bandwidth, and wherein the sum satisfies the predetermined access threshold when the sum is greater than or equal to the predetermined access threshold. In some embodiments, the one or more volatile memory dies include one or more HBM dies. In some embodiments, the one or more non-volatile memory dies include one or more NAND dies.

In some embodiments, the respective bandwidth for the one or more non-volatile memory dies can be determined based on one or more of: a physical saturation of the one or more non-volatile memory dies, a logical saturation of the one or more non-volatile memory dies, a temperature of the one or more non-volatile memory dies, a reliability of the one or more non-volatile memory dies, a number of memory channels of the one or more non-volatile memory dies, or a physical structure of memory cells of the one or more non-volatile memory dies. The factors are further described above with reference to FIG. 2.

At operation 353, the controller writes first respective portions of the first data to the one or more volatile memory dies and the one or more non-volatile memory dies, wherein first respective sizes of the respective portions are based on the first respective access bandwidths.

At operation 354, the controller receives a second write request to write second data to the on-chip cache.

At operation 355, the controller writes respective portions of the second data to the one or more volatile memory dies and the one or more non-volatile memory dies, wherein second respective sizes of the respective portions are based on the first respective access bandwidths.

At operation 356, the controller receives a third write request to write third data to the on-chip cache.

At operation 357, the controller determines a remaining access bandwidth as a difference between an on-chip cache maximum bandwidth and a sum of the respective access bandwidths. The controller here can determine whether there is remaining bandwidth available for performing the third write request concurrently with the first or the second write request.

At operation 358, the controller determines whether the remaining access bandwidth satisfies an access threshold. The access threshold, as described above, can refer to a minimum access bandwidth for performing an access operation, due to physical or logical requirements of the on-chip cache and/or characteristics of the access request.

At operation 359, responsive to determining the remaining access bandwidth satisfies the access threshold, the controller determines second respective access bandwidths for the one or more volatile memory dies and the one or more non-volatile memory dies.

At operation 310, the controller writes respective portions of the second data to the one or more volatile memory dies and the one or more non-volatile memory dies concurrently with writing respective portions of the first data.

In some embodiments, the controller receives a read request to read fourth data from the on-chip cache. In some embodiments, the controller can read respective portions of the read data from the respective one one or more volatile memory dies and the one or more non-volatile memory dies using previously determined respective bandwidths (e.g., the first respective bandwidths or the second respective bandwidths). In alternative embodiments, the controller can determine third respective bandwidths to perform the read request and perform the read request using the determined third respective bandwidths.

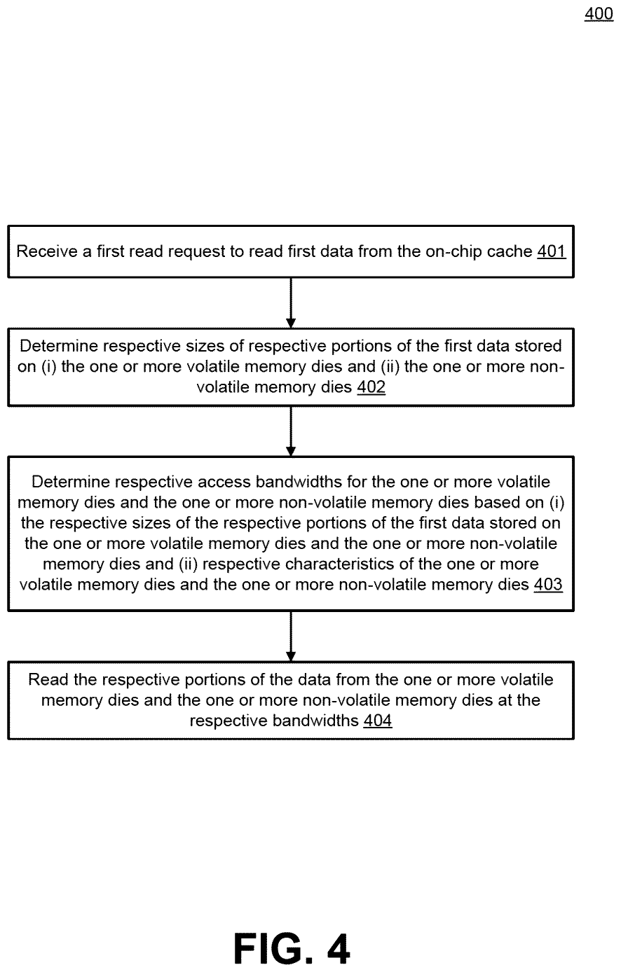

FIG. 4 is a flow chart of an example method 400 for performing traffic load management between high-bandwidth memory (HBM) and non-volatile memory (NVM) on a processing die according to some aspects of the disclosure. The method 400 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 400 is performed by the controller 122 of FIG. 1 and/or the controller 222 of FIG. 2. In another illustrative example, the method 300 is performed by the memory sub-system controller 715 of FIG. 7. In another illustrative example, the method 300 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 401, the controller performing the method 400 receives a first read request to read first data from the on-chip cache.

At operation 402, the controller determines respective sizes of respective portions of the first data stored on (i) the one or more volatile memory dies and (ii) the one or more non-volatile memory dies. In some embodiments, the controller determines the size of a portion of the first data stored on the one or more volatile memory dies. In some embodiments, the controller determines the size of a portion of the first data stored on the one or more non-volatile memory dies.

At operation 403, the controller determines respective access bandwidths for the one or more volatile memory dies and the one or more non-volatile memory dies based on (i) the respective sizes of the respective portions of the first data stored on the one or more volatile memory dies and the one or more non-volatile memory dies and (ii) respective characteristics of the one or more volatile memory dies and the one or more non-volatile memory dies. In some embodiments, the controller determines an access bandwidth for the one or more volatile memory dies. The controller can use the determined size of the portion of the first data stored on the one or more volatile memory dies to determine the access bandwidth for the one or more volatile memory dies. In some embodiments, the controller determines an access bandwidth for the one or more non-volatile memory dies. The controller can use the determined size of the portion of the first data stored on the one or more non-volatile memory dies to determine the access bandwidth for the one or more non-volatile memory dies.

At operation 404, the controller reads the respective portions of the data from the one or more volatile memory dies and the one or more non-volatile memory dies at the respective bandwidths. In some embodiments, the controller reads the portion of the first data from the one or more volatile memory dies at the determined access bandwidth for the one or more volatile memory dies. In some embodiments, the controller reads the portion of the first data from the one or more non-volatile dies at the determined access bandwidth for the one or more non-volatile memory dies.

FIG. 5A shows an example high-level component diagram of a hybrid NVM/HBM device implemented in accordance with aspects of the present disclosure. As schematically illustrated by FIG. 5A, the hybrid memory and compute device 500A may be implemented as an integrated circuit (IC) that includes a compute die 510, a logic die 520, one or more NVM dies 530A-530K, and one or more volatile memory (VM) dies 540A-540N, all the dies being disposed on a common package substrate 550.

Disposed on the compute die 510 are one or more processing units (e.g., one or more GPUs 512 and/or one or more CPUs 514) and their respective auxiliary circuitry, including local memory, input/output (I/O) interfaces, etc., which are omitted from FIG. 5A for clarity and conciseness. While a single compute die 510 is shown in FIG. 5A for clarity and conciseness, in various other implementations, device 500A may include two or more compute dies 510.

In some implementations, an NVM die 530 may be represented by a NAND die. In some implementations, one or more NVM dies 530 may be single-level cell (SLC) NAND dies, which exhibit better endurance and lower access latency as compared, e.g., to multiple-level cell (MLC), triple-level cell (TLC), or quad-level cell (QLC) dies. In some implementations, a VM die 540 may be represented by an HBM dynamic random-access memory (DRAM) die.

While a single logic die 520 is shown in FIG. 5A for clarity and conciseness, in various other implementations, device 500A may include two or more logic dies 520.

The stacked VM dies 540, NVM dies 530, and the logic die 520 may be interconnected by through-silicon vias (TSVs) 570A-570Z and microbumps 580A-580Y. A TSV is a high-performance interconnect technique that utilizes a vertical electrical connection (via) that passes through a silicon wafer or die. “Microbumps” are small raised spheres which are made of a conductive material and connect a die with another die or a substrate, thus serving as conduits delivering electrical signals from one part of a chip to another.

The components disposed on the compute die 510 may communicate with the components disposed on the logic die 520, components disposed on the NVM dies 530A-530K, and/or components disposed on the VM dies 540A-540N via respective physical interfaces (PHYs) 518, 524 interconnected by the interposer 560. An interposer is an electrical interface routing electrical signals between one socket or connection and another socket or connection. Thus, the memory access requests issued by the processing units residing on the compute die 510 may be transmitted via the interposer 560 to the logic die 520.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space.

In some implementations, no address translation (other than offsetting by a predefined value) may be required for the logical addresses that are below the upper limit of the user-addressable capacity of the VM dies 540A-540N. In other words, the logical addresses within the user-addressable capacity of the VM dies 540A-540N will directly (e.g., with an optional offset) reference respective memory locations on the VM dies 540A-540N, while the logical addresses exceeding the upper limit of the user-addressable capacity of the VM dies 540A-540N:
if LBA<=NVM Capacity then PA_{VM}=LBA+Offset
   else PA_{NVM}=L2P[LBA]
where LBA is the logical block address,
NVM Capacity is he user-addressable capacity of the VM dies 540A-540N,
PA_{VM} is the physical address of a transfer unit (TU) residing on the VM dies 540A-540N,
Offset is the optional offset to be applied to the logical addresses,
PA_{NVM} is the physical address of a TU residing on the VM dies 530A-530K,
L2P[ . . . ] is the logical-to-physical (L2P) address translation table, and
L2P[LBA] is the physical address corresponding to the specified LBA.

In an illustrative example, the total user-addressable capacity of the VM dies 540A-540N may be 40 GB, while the total user-addressable capacity of the NVM dies 530A-530K may be 128 GB. Thus, the memory access requests initiated by the compute die 510 with respect to transfer units (TUs) (such as memory pages, blocks, etc.) referenced by logical addresses below the upper limit of the user-addressable capacity of the VM dies 540A-540N may be satisfied directly via the physical interfaces 518 and 524 accessing the VM dies 540A-540N.

Conversely, memory access requests initiated by the compute die 510 with respect to TUs referenced by the logical addresses exceeding the upper limit of the user-addressable capacity of the VM dies 540A-540N may be sent to the controller 522, which may translate these logical addresses to corresponding physical addresses of TUs residing on the NVM dies 530A-530K. The address translation may be facilitated by a logical-to-physical (L2P) table, which may be indexed by the logical addresses so that each entry of the table would store a physical address corresponding to the logical address identifying the entry:

PA_{NVM}=L2P[LBA].

FIG. 5B shows another example high-level component diagram of a hybrid NVM/HBM device 500B implemented in accordance with aspects of the present disclosure. As schematically illustrated by FIG. 5B, the hybrid memory device 500B may be implemented as an integrated circuit (IC) that includes a logic die 520, one or more NVM dies 530A-530K, and one or more volatile memory (VM) dies 540A-540N, all the dies being disposed on a common package substrate 550. While a single logic die 520 is shown in FIG. 5B for clarity and conciseness, in various other implementations, device 500B may include two or more logic dies 520. The stacked VM dies 540, NVM dies 530, and the logic die 520 may be interconnected by through-silicon vias (TSVs) 570A-570Z and microbumps 580A-580Y.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space, as described in more detail herein above.

The host system (not shown in FIG. 5B) may communicate with the components disposed on the logic die 520, components disposed on the NVM dies 530A-530K, and/or components disposed on the VM dies 540A-540N via the host interface 524. In some implementations, the host interface 524 may be represented by a logical host interface (e.g., NVMe) operating over a physical host interface (e.g., PCIe, CXL, SATA Express, etc.).

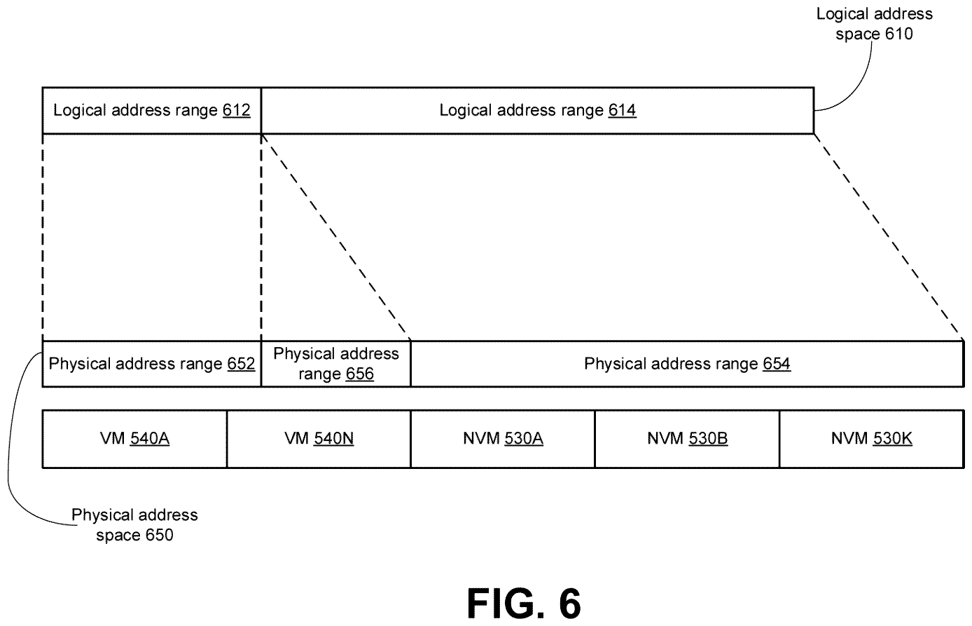

FIG. 6 schematically illustrates the example logical address space 610 and physical address space 650 of the device 500A-510B in accordance with aspects of the present disclosure. As schematically illustrated by FIG. 6, the logical address space 610 includes two logical address ranges 612 and 614.

The logical address range 612, the size of which matches the size of the user-addressable capacity of the VM dies 540A-540N, contains logical addresses that directly (e.g., with an optional offset) reference respective memory locations residing within the VM physical address range 652 corresponding to the user-addressable capacity of the VM dies 540A-540N.

The logical address range 614, residing immediately above the logical address range 612, contains logical addresses that are translatable to corresponding physical addresses identifying TUs that reside within the NVM physical address range 654 on the NVM dies 530A-530K. In some embodiments, the discussion with reference to FIG. 6 is applicable to the VM dies 140 and the NVM dies 130 of FIG. 1, where although both can be treated as on-chip cache, the VM dies 140 is faster-access cache and the NVM dies 130 is slower-access cache, and thus designed to back up the faster-access cache.

In some implementations, one or more physical address sub-ranges within the physical address ranges 652 and/or 654 may be reserved by the controller 522 for performing, e.g., various memory management and/or other system tasks. Accordingly, the size of the physical address range 652 and the size of the corresponding logical address range 612 may be less than the combined capacity of the VM dies 540A-540N. Similarly, the size of the physical address range 654 and the size of the corresponding logical address range 614 may be less than the combined capacity of the NVM dies 530A-530K.

In some implementations, content of the NVM dies 530A-530K may not be directly accessible by the processing units 512, 514 or the compute die 110 (FIG. 1). In an illustrative example, the controller 522 may reserve the capacity of the VM dies 540A-540N (or 140A-140N in FIG. 1) as fast-access cache to store certain portions (e.g., most recently accessed portions or most frequently accessed portions) of the slower-access content of the NVM dies 530A-530K (or 130A-130K of FIG. 1), although both may still be treated as the on-chip cache 121.

In operation, responsive to receiving a memory read request specifying a logical memory address to be read, the memory interface implemented by the logic die 520 may determine whether the logical memory address specified by the memory read request falls within the VM physical address range 652 corresponding to the fast-access capacity of the VM dies 540A-540N.

If the logical memory address specified by the memory read request falls within the VM physical address range 652, the memory interface implemented by the logic die 520 may read, from a volatile memory die 540A-540N, the data item stored in the location identified by the logical memory address. In some embodiments, the data item is returned to the requestor (e.g., a processing unit 512, 514 or the compute die 110) via the memory interface (e.g., the physical interfaces 518, 524).

Conversely, if the logical memory address specified by the memory read request falls outside the VM physical address range 652 and/or 656, the controller 522 may translate the logical address to a corresponding physical address within the physical address range 654 and/or 656. The controller 522 may then read the data stored at the TU (e.g., a block or a page) referenced by the physical address and return the data to the requestor (e.g., a processing unit 512, 514) via the memory interface (e.g., the physical interfaces 518, 524).

The controller 522 may determine whether the contents of the TU identified by the physical address had previously been cached in the VM dies 540A-540N (or 140A-140N of FIG. 1 of the fist-level cache 121). Should a hit occur, the read request may be satisfied from the VM dies. The contents of the identified cache line may be returned to the requestor (e.g., a processing unit 512, 514 or compute die 110) via a volatile memory interface (e.g., including the physical interfaces 518 and/or 524). In case of a miss, the controller 522 may allocate a new cache entry in the VM dies 540A-540N, read the contents of the TU identified by the physical address, store the retrieved data item in the newly allocated cache entry, and return the data item to the requestor processing unit 512, 514 via the volatile memory interface.

With additional reference to FIG. 1, in some embodiments, the on-chip cache 121 may implement the write-through policy. Accordingly, responsive to subsequently receiving a memory write request, the controller 122 or 522 may identify the cache entry whose tag matches the physical address corresponding to the logical address specified by the request. The controller 122 or 522 may store the data item specified by the memory request to the identified cache entry. The controller 122 or 522 may then store the content of the cache entry to the TU identified by the physical address. In various use cases, the compute device 102 or the compute device 500A, 500B may be employed for both training and inference stages of AI models, such as large language models (LLMs), generative transformer models, etc.

In an illustrative example, the hybrid memory and the compute die 110, or hybrid memory and the compute device 500A, and/or the hybrid memory device 500B may be utilized for training of an artificial intelligence (AI) model. In another illustrative example, the compute device 102 and/or the hybrid memory devices 500A-500B may be utilized for implementing an inference stage of an artificial intelligence (AI) model.

In an illustrative example, training an AI model involves the need of storing and frequently accessing or modifying large amounts of data, including model states, weights, parameters, etc. This need can be effectively addressed by the compute device 102, the hybrid memory and compute device 500A, and/or the hybrid memory device 500B, which significantly increases the size of the local memory co-located with one or more processing units or the compute die 110.

In another illustrative example, performing an inference by an AI model involves handling a very large size of the model context, which requires the memory capacity that may exceed that of currently available solutions. This requirement is effectively met by the compute device 102, the hybrid memory and compute device 500A, and/or the hybrid memory device 500B, which can significantly increase the size of the local memory co-located with one or more processing units or the compute die 110.

FIG. 7 illustrates a high-level component diagram of an example computing system 700 that includes a memory sub-system 710 in accordance with some implementations of the present disclosure. The memory sub-system 710 can include one or more memory devices 730A-730N, which may include one or more volatile memory devices, and/or one or more non-volatile memory devices. In an illustrative example, one or more memory devices 730A-730N may be represented by the compute device 102 or hybrid NVM/HBM devices 500A and/or 500B.

The memory sub-system 710 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 700 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 700 can include a host system 720 that is coupled to one or more memory sub-systems 710. In some implementations, the host system 720 is coupled to different types of memory sub-system 710. FIG. 7 illustrates one example of a host system 720 coupled to one memory sub-system 710. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 720 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 720 uses the memory sub-system 710, for example, to write data to the memory sub-system 710 and read data from the memory sub-system 710.

The host system 720 can be coupled to the memory sub-system 710 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 720 and the memory sub-system 710. The host system 720 can further utilize an NVM Express (NVMe) interface to access the memory components (e.g., the one or more memory device(s) 730A-730N) when the memory sub-system 710 is coupled with the host system 720 by the physical host interface (e.g., PCIe or CXL bus). The physical host interface can provide an interface for passing control, address, data, and other signals between the memory sub-system 710 and the host system 720. FIG. 7 illustrates a memory sub-system 710 as an example. In general, the host system 720 can access multiple memory sub-systems via a same communication connection, multiple separate communication connections, and/or a combination of communication connections.

The memory devices 730A-730N can include any combination of the different types of non-volatile memory devices and/or volatile memory devices. In an illustrative example, one or more memory devices 730A-730N may be represented by the compute device 102 or by the hybrid NVM/HBM devices 500A and/or 500B.

The volatile memory devices can be, e.g., random access memory (RAM), such as dynamic random-access memory (DRAM) and synchronous dynamic random-access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 730A-730N can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some implementations, each of the memory devices 730A-730N can include one or more arrays of memory cells such as SLCs, MLCs, TLCs, QLCs, or any combination of such. In some implementations, a particular memory device can include an SLC portion, and an MLC portion, a TLC portion, or a QLC portion of memory cells. The memory cells of the memory devices 730A-730N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 730A-730N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 715 can communicate with the memory device(s) 730A-730N to perform operations such as reading data, writing data, or erasing data at the memory devices 730A-730N and other such operations. The memory sub-system controller 715 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 715 can be a microcontroller, special purpose logic circuitry (e.g., a field programmable gate array (FPGA), an application specific integrated circuit (ASIC), etc.), or other suitable processor.

The memory sub-system controller 715 can include a processor 717 (e.g., a processing device) configured to execute instructions stored in a local memory 719. In the illustrated example, the local memory 719 of the memory sub-system controller 715 includes an embedded memory configured to store instructions for performing various processes, operations, logic flows, and routines that control operation of the memory sub-system 710, including handling communications between the memory sub-system 710 and the host system 720.

In some implementations, the local memory 719 can include memory registers storing memory pointers, fetched data, etc. The local memory 719 can also include read-only memory (ROM) for storing micro-code. While the example memory sub-system 710 in FIG. 7 has been illustrated as including the memory sub-system controller 715, in another implementation of the present disclosure, a memory sub-system 710 does not include a memory sub-system controller 715, and can instead rely upon external control (e.g., provided by an external host, or by a processor or controller separate from the memory sub-system).

In general, the memory sub-system controller 715 can receive commands or operations from the host system 720 and can convert the commands or operations into instructions or appropriate commands to achieve the desired access to the memory device(s) 730A-730N. The memory sub-system controller 715 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 730A-730N. The memory sub-system controller 715 can further include host interface circuitry to communicate with the host system 720 via the physical host interface. The host interface circuitry can convert the commands received from the host system into command instructions to access the memory device(s) 730A-730N as well as convert responses associated with the memory device(s) 730A-730N into information for the host system 720.

The memory sub-system 710 can also include additional circuitry or components that are not illustrated. In some implementations, the memory sub-system 710 can include a cache or buffer (e.g., DRAM) and address circuitry (e.g., a row decoder and a column decoder) that can receive an address from the memory sub-system controller 715 and decode the address to access the memory device(s) 730A-730N.

In some implementations, the memory device(s) 730A-730N include local media controllers 735 that operate in conjunction with memory sub-system controller 715 to execute operations on one or more memory cells of the memory device(s) 730A-730N. An external controller (e.g., memory sub-system controller 715) can externally manage the memory device 730A-730N (e.g., perform media management operations on the memory device(s) 730A-730N). In some implementations, a memory device 730A-730N is a managed memory device, which is a raw memory device (e.g., memory array 704) having control logic (e.g., local controller 735) for media management within the same memory device package. An example of a managed memory device is a managed NAND (MNAND) device. Memory device(s) 730A-730N, for example, can each represent a single die having some control logic (e.g., local media controller 735) embodied thereon. In some implementations, the local media controller 735 may be represented by the controller 122 of FIG. 1 or the controller 522 of FIGS. 5A-5B.

In some implementations, the memory sub-system 710 includes a memory interface 713 that is responsible for handling interactions of memory sub-system controller 715 with the memory devices of memory sub-system 710, such as memory devices 730A-730N. For example, the memory interface 713 can send or transmit memory access commands corresponding to requests received from host system 720 to memory devices 730A-730N, such as program commands, read commands, or other commands. In addition, the memory interface 713 can receive data from devices 730A-730N, such as data retrieved in response to a read command or a confirmation that a program command was successfully performed. In some implementations, the memory sub-system controller 715 includes at least a portion of the memory interface 713. For example, the memory sub-system controller 715 can include a processor 717 (processing device) configured to execute instructions stored in local memory 719 for performing the operations described herein.

In some implementations, the host system 720 implements an ML/AI framework 750. ML/AI framework 750 can include one or more ML models, a processing engine, and a training engine, among other components, which can be used to perform any automated task (e.g., classify or categorize documents or images). In order to train the one or more ML models, ML/AI framework 750 can issue requests to read the training data, which may be stored on one or more memory devices 730A-730N, and process the training data accordingly. In some implementations, ML/AI framework 750 is executed by multiple processing units (e.g., GPUs and/or CPUs) which can process many threads/streams in parallel.

In some implementations, host system 720 could include hundreds of parallel processing threads that can request and process different subsets of the training data concurrently. In some implementations, at least some of the processing tasks of the ML/AI framework 750 are performed by the compute die 110 of the compute device 102 (FIG. 1) or by the processing units 512, 514 residing on the hybrid memory device 500A of FIG. 5A. In embodiments, one or more of the compute device 102 or the hybrid memory devices 500A are employed by the memory sub-system as memory devices 730A-730N.

Once a certain amount of training is complete, ML/AI framework 750 can enter an inference phase to analyze different input data. The input data can similarly be stored on memory device 102 of the same or a different memory sub-system 710. In some implementations, ML/AI framework 750 can issue requests to read the input data from memory sub-system 710 and store a copy of the input data in the host memory 722.

In some implementations, the host system 720 utilizes a set of queues to track the memory access commands issued to the memory sub-system 710 (e.g., requests to read data for ML/AI framework 750). For example, the host system 720 can include a number of submission queues, storing submission queue entries representing the memory access commands issued to the memory sub-system 710, and a number of completion queues, storing completion queue entries received from the memory sub-system 710 to indicate that the corresponding memory access commands have been executed. In some implementations, the host system 720 can maintain these queues in the host memory 722.

The host memory 722 may include one or more DRAM devices, HBM devices, and/or other types of memory devices. In some implementations, the host memory 722 includes the compute device 102 or one of the hybrid HBM/NVM memory devices 500A and/or 500B of FIGS. 5A-5B.

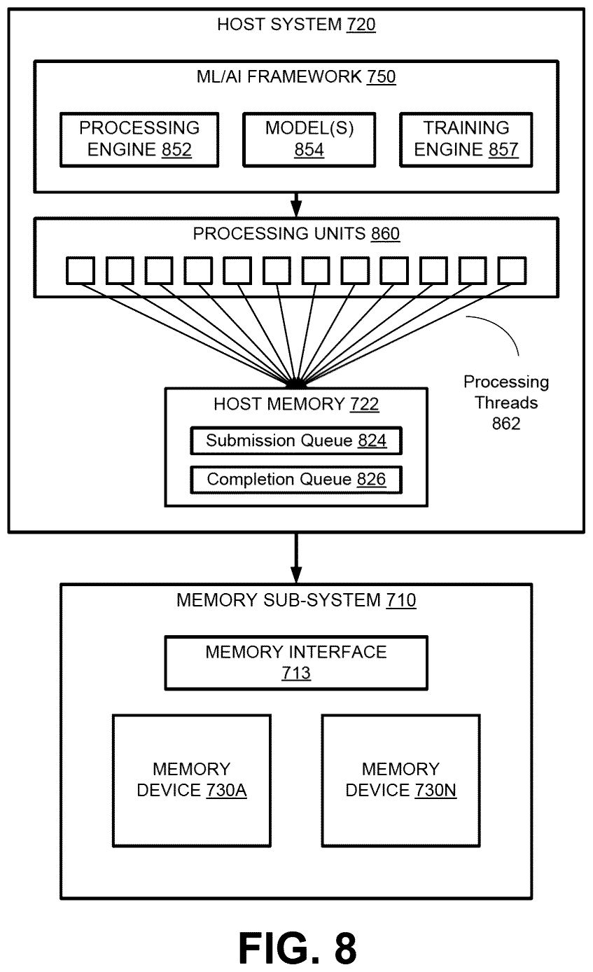

FIG. 8 is a block diagram illustrating a system for performing AI model inference operations using memory devices and/or host systems implemented in accordance with aspects of the present disclosure. As illustrated, host system 720 includes ML/AI framework 750 which can be executed by a number of processing threads 862. Host system 720 further includes host memory 722, including submission queues 824 and completion queues 826. In some implementations, ML/AI framework 750 includes a processing engine 852, one or more machine learning models 854, and a training engine 857, among other components, which can be used to perform any automated task (e.g., classify or categorize documents or images). Depending on the implementation one or more components that make up ML/AI framework 750 can be distributed across multiple different computing devices (e.g., host computers, servers, etc.). In some implementations, processing engine 852 may use a set of trained machine learning models 854 that are trained and used to perform any number of automated operations. The processing engine 852 may also preprocess any received input data prior to using the data for training of the set of machine learning models 854 and/or applying the set of trained machine learning models 854 to the input data. Based on the output of the set of trained machine learning models 854, the processing engine 852 may obtain, for example, a classification and/or category of the input data, as well an assessment of the classification.

In some implementations, at least some of the processing tasks of the ML/AI framework 750 are performed by the compute die 110 residing on the compute device 102 of FIG. 1 or by processing units 512, 514 residing on the compute die 510 of a hybrid memory device 500A of FIG. 5A. In embodiments, the compute device 102 or one or more hybrid memory devices 500A are employed by the memory sub-system as memory devices 730A-630N.

The set of machine learning models 854 may refer to model artifacts that are created by the training engine 857 using training data that includes training inputs and corresponding target outputs (i.e., correct answers for respective training inputs). During training, patterns in the training data that map the training input to the target output (i.e., the answer to be predicted) can be found, and are subsequently used by the machine learning models 854 for future predictions. Depending on the implementation, the set of machine learning models 854 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 854, ML/AI framework 750 can issue requests to read training data and input data, which may be stored on memory device 102 of memory sub-system 710, and process the data accordingly. In some implementations, these memory access requests are sent by the parallel processing threads 862 being executed by respective processing units 860. The processing units 860 can include a number of general-purpose processing devices such as microprocessors, central processing units (CPUs), or the like, or more specialized processing devices, such as graphics processing units (GPUs), which may be optimized for performing high-speed sequential processing operations. Thus, at least some of the processing units 860 may be the compute device 102 of FIG. 1.

Depending on the implementation there can be any number of processing units 860 (e.g., tens or hundreds), each executing a respective one or more of the processing threads 862. Each processing thread 862 represents a series of sequential operations directed to memory sub-system 710 (e.g., read requests for separate segments of an element of training or input data stored at memory sub-system 710). Due to the large relative size of the training data or input data, each element may be broken up into separate segments of a smaller fixed size and stored at sequential memory addresses in memory sub-system 710. Thus, in order to read the entire element of data, a sequence of multiple read requests can be issued to obtain all of the separate segments. Each processing thread 862 can include a series of read requests to read the segments of a different element of data from memory sub-system 710. Upon the read requests from each processing thread 862 being generated, the requests can be stored as entries in one of submission queues 824, from which they can be issued to memory sub-system 710. Received responses to the requests from memory sub-system 710 can be stored as entries in one of completion queues 826, retrieved by processing threads 862 and provided to ML/AI framework 750 for execution in either a training phase or an inference phase.

FIG. 9 illustrates an example machine of a computer system 900 within which a set of instructions, for causing the machine to perform any one or more of the methodologies discussed herein, can be executed. In some implementations, the computer system 900 can correspond to a host system (e.g., the host system 720 of FIG. 7) that includes, is coupled to, or utilizes a memory sub-system (e.g., the memory sub-system 710 of FIG. 7) or can be used to perform the operations of a controller (e.g., to execute an operating system to perform operations corresponding to the memory interface 713 or memory sub-system controller 715 of FIG. 7). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage system 918, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 928 for performing the operations and steps discussed herein. The computer system 900 can further include a network interface device 908 to communicate over the network 920.

The data storage system 918 can include a machine-readable storage medium 924 (also known as non-transitory computer-readable storage medium) on which is stored one or more sets of instructions 928 (executable instructions) or software embodying any one or more of the methodologies or functions described herein. The instructions 928 can also reside, completely or at least partially, within the main memory 904 and/or within the processing device 902 during execution thereof by the computer system 900, the main memory 904 and the processing device 902 also constituting machine-readable storage media. The machine-readable storage medium 924, data storage system 918, and/or main memory 904 can correspond to the memory sub-system 710 of FIG. 7. In some implementations, the data storage system 918 may include the compute device 102 or one or more hybrid HBM/NVM memory devices 500A and/or 500B of FIGS. 5A-5B.

In some implementations, the instructions 928 include instructions to implement functionality corresponding to the memory interface 713 of FIG. 7). While the machine-readable storage medium 924 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A device comprising:
a compute die disposed on a package substrate;
an on-chip cache disposed on the package substrate and coupled to the compute die, wherein the on-chip cache comprises one or more volatile memory dies and one or more non-volatile memory dies; and
a memory controller, disposed on the package substrate, and coupled to the compute die and the on-chip cache, wherein the memory controller is configured to perform operations comprising:
receiving a first write request to write first data to the on-chip cache;
determining a first access bandwidth for the one or more volatile memory dies based on characteristics of the one or more volatile memory dies;
determining a second access bandwidth for the one or more non-volatile memory dies based on characteristics of the one or more non-volatile memory dies;
writing a first portion of the first data to the one or more volatile memory dies, wherein a first size of the first portion is based on the first access bandwidth; and
writing a second portion of the first data to the one or more non-volatile memory dies, wherein a second size of the second portion is based on the second access bandwidth.

2. The device of claim 1, wherein the memory controller is configured to perform operations further comprising:
receiving a second write request to write second data to the on-chip cache, wherein the second write request is received prior to a completion of the first write request;
determining a remaining access bandwidth as a difference between an on-chip cache maximum bandwidth and a sum of the respective access bandwidths;
determining whether the remaining access bandwidth satisfies an access threshold;
responsive to determining the remaining access bandwidth satisfies the access threshold, determining a third access bandwidth for at least one of the one or more volatile memory dies or the one or more non-volatile memory dies; and
writing a portion of the second data to the at least one of the one or more volatile memory dies or the one or more non-volatile memory dies concurrently with writing a respective portion of the first data to at least one of the one or more volatile memory dies or the one or more non-volatile memory dies.

3. The device of claim 1, wherein the one or more volatile memory dies comprises one or more high-bandwidth memory (HBM) dies.

4. The device of claim 1, wherein the first write request is received at the memory controller from one or more processing devices of a graphics processing unit (GPU).

5. The device of claim 1, wherein a second bandwidth for the one or more non-volatile memory dies is determined based on one or more of: a physical saturation of the one or more non-volatile memory dies, a logical saturation of the one or more non-volatile memory dies, a temperature of the one or more non-volatile memory dies, a reliability score for the one or more non-volatile memory dies, a number of memory channels of the one or more non-volatile memory dies, or a physical structure of memory cells of the one or more non-volatile memory dies.

6. The device of claim 1, wherein a sum of the first access bandwidth and the second access bandwidth satisfies a predetermined access threshold.

7. The device of claim 6, wherein the predetermined access threshold is based on an on-chip cache access bandwidth, and wherein the sum satisfies the predetermined access threshold when the sum is greater than or equal to the predetermined access threshold.

8. The device of claim 1, wherein the memory controller is configured to perform the operations further comprising:
receiving a read request to read second data from the on-chip cache;
reading respective portions of the second data from the one or more volatile memory dies at the first access bandwidth and the one or more non-volatile memory dies at the second access bandwidth.

9. The device of claim 1, wherein the memory controller is configured to perform the operations further comprising:
receiving a read request to read second data from the on-chip cache;
determining a first size of a first portion of the second data stored on the one or more volatile memory dies;
determining a second size of a second portion of the second data stored on the one or more non-volatile memory dies;
determining a third access bandwidth for the one or more volatile memory dies based on the first size of the first portion;
determining a fourth access bandwidth for the one or more non-volatile memory dies based on the second size of the second portion; and
reading the first portion from the one or more volatile memory dies and the second portion from the one or more non-volatile memory dies.

10. A method comprising:
receiving a first write request to write first data to an on-chip cache, wherein the on-chip cache comprises one or more volatile memory dies and one or more non-volatile memory dies;
determining a first access bandwidth for the one or more volatile memory dies based on characteristics of the one or more volatile memory dies;
determining a second access bandwidth for the one or more non-volatile memory dies based on characteristics of the one or more non-volatile memory dies;
writing a first portion of the first data to the one or more volatile memory dies, wherein a first size of the first portion is based on the first access bandwidth; and
writing a second portion of the first data to the one or more non-volatile memory dies, wherein a second size of the second portion is based on the second access bandwidth.

11. The method of claim 10, further comprising:
receiving a second write request to write second data to the on-chip cache, wherein the second write request is received prior to a completion of the first write request;
determining a remaining access bandwidth as a difference between an on-chip cache maximum bandwidth and a sum of the first access bandwidth and the second access bandwidth;
determining whether the remaining access bandwidth satisfies an access threshold;
responsive to determining the remaining access bandwidth satisfies the access threshold, determining a third access bandwidth for at least one of the one or more volatile memory dies or the one or more non-volatile memory dies; and
writing a portion of the second data to the at least one of the one or more volatile memory dies or the one or more non-volatile memory dies concurrently with writing a respective portion of the first data to at least the one or more volatile memory dies or the one or more non-volatile memory dies.

12. The method of claim 10, wherein the one or more volatile memory dies comprises one or more high-bandwidth memory (HBM) dies.

13. The method of claim 10, wherein the first write request is received at a memory controller operatively coupled with the on-chip cache from one or more processing devices of a graphics processing unit (GPU).

14. The method of claim 10, wherein a second bandwidth for the one or more non-volatile memory dies is determined based on one or more of: a physical saturation of the one or more non-volatile memory dies, a logical saturation of the one or more non-volatile memory dies, a temperature of the one or more non-volatile memory dies, a reliability score for the one or more non-volatile memory dies, a number of memory channels of the one or more non-volatile memory dies, or a physical structure of memory cells of the one or more non-volatile memory dies.

15. The method of claim 10, wherein a sum of the first access bandwidth and the second access bandwidth satisfies a predetermined access threshold.

16. The method of claim 15, wherein the predetermined access threshold is based on an on-chip cache access bandwidth, and wherein the sum satisfies the predetermined access threshold when the sum is greater than or equal to the predetermined access threshold.

17. The method of claim 10, further comprising:
receiving a read request to read second data from the on-chip cache;
reading respective portions of the second data from the one or more volatile memory dies at the first access bandwidth and the one or more non-volatile memory dies at the second access bandwidth.

18. The method of claim 10, further comprising:
receiving a read request to read second data from the on-chip cache;
determining a first size of a first portion of the second data stored on the one or more volatile memory dies;
determining a second size of a second portion of the second data stored on the one or more non-volatile memory dies;
determining a third access bandwidth for the one or more volatile memory dies based on the first size of the first portion;
determining a fourth access bandwidth for the one or more non-volatile memory dies based on the second size of the second portion; and
reading the first portion from the one or more volatile memory dies and the second portion from the one or more non-volatile memory dies.

19. A non-transitory computer-readable storage medium comprising executable instructions that, when executed by a controller managing a memory device comprising a plurality of memory cells, cause the controller perform operations comprising:
receiving a first write request to write first data to an on-chip cache, wherein the on-chip cache comprises one or more volatile memory dies and one or more non-volatile memory dies;
determining a first access bandwidth for the one or more volatile memory dies based on characteristics of the one or more volatile memory dies;
determining a second access bandwidth for the one or more non-volatile memory dies based on characteristics of the one or more non-volatile memory dies;
writing a first portion of the first data to the one or more volatile memory dies, wherein a first size of the first portion is based on the first access bandwidth; and
writing a second portion of the first data to the one or more non-volatile memory dies, wherein a second size of the second portion is based on the second access bandwidth.

20. The non-transitory computer-readable storage medium of claim 19, wherein the one or more volatile memory dies comprises one or more high-bandwidth memory (HBM) dies.
